(19) United States
(12) Patent Application Publication
(10) Pub. No.: US 2025/0243951 A1
(43) Pub. Date: Jul. 31, 2025

(54) FILTER TO TANK FLOW TUBE ARRANGEMENT

(71) Applicant: Donaldson Company, Inc., Bloomington, MN (US)

(72) Inventors: Michael J. Gustafson, Minnetonka, MN (US); Erik P. Anderson, Eagan, MN (US)

(21) Appl. No.: 19/024,836

(22) Filed: Jan. 16, 2025

Related U.S. Application Data
(60) Provisional application No. 63/624,993, filed on Jan. 25, 2024.

(51) Int. Cl. F16L 9/00; B01D 35/027

(52) U.S. Cl. CPC F16L 9/006; B01D 35/027; B01D 2201/347

(57) ABSTRACT

A flow tube for use connecting a filter head to a bulkhead fitting in a tank includes a hollow tube having a first open end and a second open end; and the tube having a first bulbous-shaped wall adjacent to at least one of the first open end or second open end. An in-tank hydraulic filter system uses the flow tube. The system includes a hydraulic tank having a surrounding wall defining an interior volume; the surrounding wall having a bulkhead fitting providing access to the interior volume; a filter assembly mounted in the interior volume of the tank; the filter assembly having a filter head with flow port; and the flow tube connecting the tank wall with the flow port.

### CROSS-REFERENCE TO RELATED APPLICATIONS

This application claims priority to U.S. provisional patent application 63/624,993, filed on Jan. 25, 2024; the disclosure of which is incorporated herein by reference in its entirety.

### TECHNICAL FIELD

This disclosure relates to arrangements for in tank filters, such as hydraulic filters. In particular, this disclosure relates to a flow tube used between the filter assembly and the tank.

### BACKGROUND

During the assembly of tanks, features located in different locations are difficult to hold within small tolerances. As a result, there is a need to accommodate those tolerances. These tolerances can be quite large in plastic rotomolded tanks. With the on-set of integrating filter assemblies to the inside of a tank, flow passages are needed to connect flow from outside the tank, to the filter assembly.

These flow tubes need to be installed after the filter assembly has been placed in the tank, so it is a blind installation.

### SUMMARY

In general, a flow tube is provided which improves the prior art.

In one aspect, a flow tube for use connecting a filter head to a bulkhead fitting in a tank comprises: (a) a hollow tube having a first open end and a second open end; and (b) the tube having a first bulbous-shaped wall adjacent to at least one of the first open end or second open end.

In examples, the tube has the first bulbous-shaped wall adjacent to the first open end, and includes a second bulbous-shaped wall adjacent to the second open end.

In some embodiments, the hollow tube consists of a straight section of the tube between the first bulbous-shaped wall and the opposite first open end or second open end.

In some embodiments, the straight section of the tube is cylindrical.

In arrangements, the first bulbous-shaped wall and second bulbous-shaped wall each has a largest diameter that is 1.01-1.1 times larger than a diameter of the straight section of the tube.

In some examples, the first bulbous-shaped wall has a largest diameter that is 1.1-1.2 times larger than a diameter of the straight section of the tube.

In some implementations, the first bulbous-shaped wall has a largest diameter that is 1.2-1.3 times larger than a diameter of the straight section of the tube.

In some embodiments, the first bulbous-shaped wall has a largest diameter that is 1.3-1.4 times larger than a diameter of the straight section of the tube.

For some examples, the first bulbous-shaped wall has a largest diameter that is between 1.4 and 1.01 times larger than a diameter of the straight section of the tube.

In one or more embodiments, the first bulbous-shaped wall has a largest diameter that is between 1.3 and 1.1 times larger than a diameter of the straight section of the tube.

In examples, first bulbous-shaped wall has a largest diameter that is between 1.3 and 1.2 times larger than a diameter of the straight section of the tube.

In some arrangements, the flow tube is plastic.

In some embodiments, the flow tube is metal.

In examples, the first bulbous-shaped wall is adjacent to the first open end, and the tube adjacent the second open end is straight.

In some embodiments, the first bulbous-shaped wall is adjacent to the first open end, and the tube adjacent the second open end defines an o-ring seat groove.

In another aspect, an in-tank hydraulic filter system is provided comprising: (a) a hydraulic tank having a surrounding wall defining an interior volume; (i) the surrounding wall having a bulkhead fitting providing access to the interior volume; (b) a filter assembly mounted in the interior volume of the tank; the filter assembly having a filter head with flow port; and (c) a flow tube connecting the bulkhead fitting to the flow port in the filter head; the flow tube including: (i) a hollow tube having a first open end and a second open end; and (ii) a first bulbous-shaped wall received within a first of the bulkhead fitting or the flow port.

In some embodiments, the bulkhead fitting includes an o-ring seal member located to form a seal with the flow tube.

In some implementations, the flow port includes a flow port o-ring seal member located to form a seal with the flow tube.

In examples, the first bulbous-shaped wall is adjacent to the first open end, and the tube adjacent the second open end defines an o-ring seat groove.

In some arrangements, the tank is plastic.

In some embodiments, the tank is metal.

A variety of examples of desirable product features or methods are set forth in part in the description that follows, and in part will be apparent from the description, or may be learned by practicing various aspects of this disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a schematic, cross-sectional view of an in-tank filter arrangement having a flow tube, constructed in accordance to principles of this disclosure;

FIG. 2 is an enlarged view of the filter and tank of FIG. 1, but without use of the flow tube;

FIG. 3 is a cross-sectional view of one embodiment of the flow tube shown connecting the filter and the tank;

FIG. 4 is a cross-sectional view of another embodiment of the flow tube shown connecting the filter and the tank;

FIG. 5 is a cross-sectional view of another embodiment of the flow tube shown connecting the filter and the tank;

FIG. 6 is a cross-sectional view of an embodiment of the flow tube, constructed in accordance with principles of this disclosure; and

FIG. 7 is a cross-sectional view of another embodiment of the flow tube, constructed in accordance with principles of this disclosure.

### DETAILED DESCRIPTION

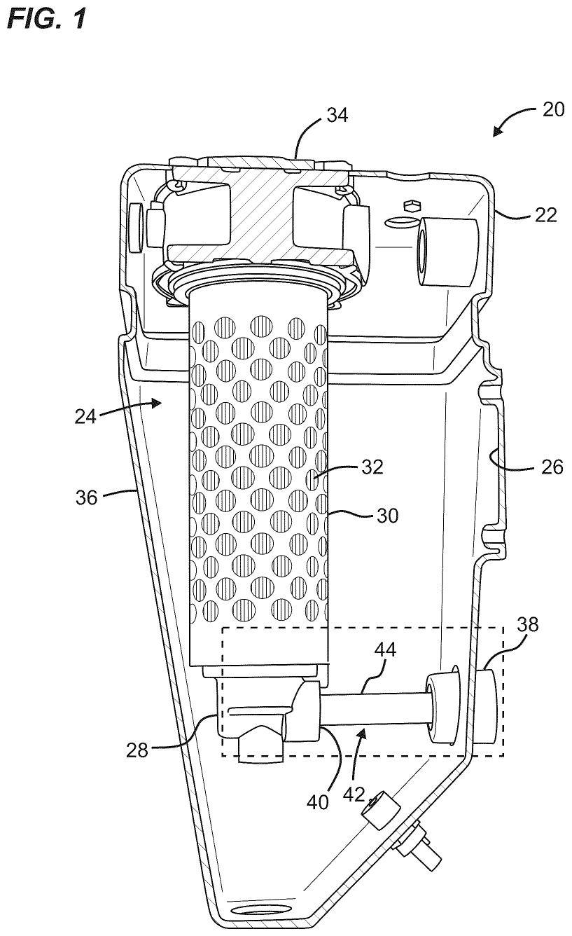

FIG. 1 shows an in-tank hydraulic filter system 20. The system 20 includes a hydraulic tank 22 and a filter assembly 24 mounted in an interior volume 26 of the tank 22. The filter assembly 24 can be a hydraulic filter, for example, and includes a filter head (or base) 28. Also visible is a strainer 30, surrounding a filter element 32. A cover member 34 on the tank 22 provides access to the interior volume 26 of the tank 22 and to the filter assembly 24.

The hydraulic tank 22 has a surrounding wall 36 defining the interior volume 26. The surrounding wall 26 has a bulkhead fitting 38 providing access to the interior volume 26.

The filter head 28 of the filter assembly 24 defines a flow port 40. The flow port 40 is for conveying a filtered liquid (such as hydraulic oil) from the filter assembly 24 to downstream components.

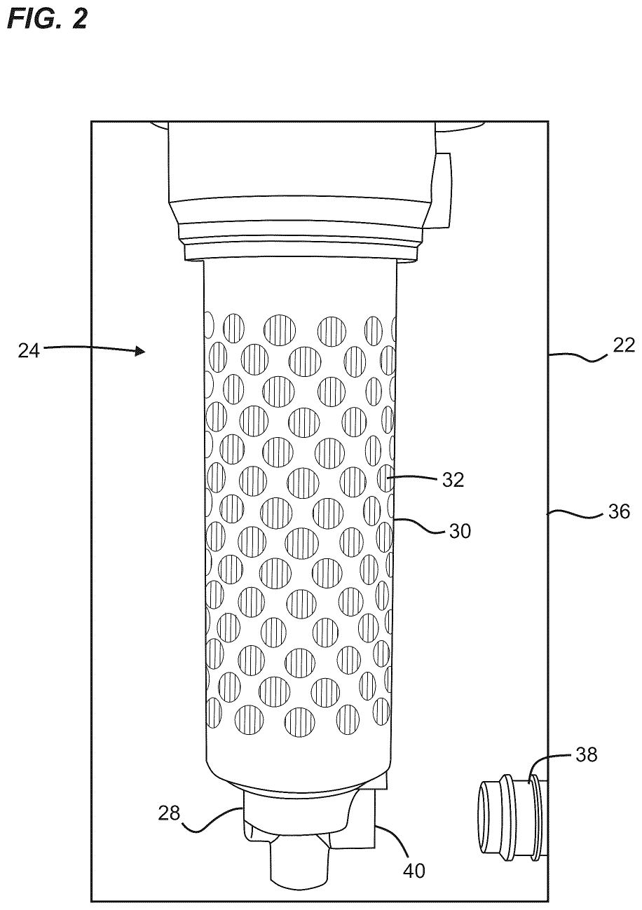

FIG. 2 shows the filter assembly 24 and the bulkhead fitting 38 in the tank wall 36, without any type of connection therebetween. It should be appreciated, from a review of FIG. 2, that if tolerances or alignment is off, it can be difficult to fit a tube between the port 40 and the bulkhead fitting 38. Flow tubes are provided to solve this problem.

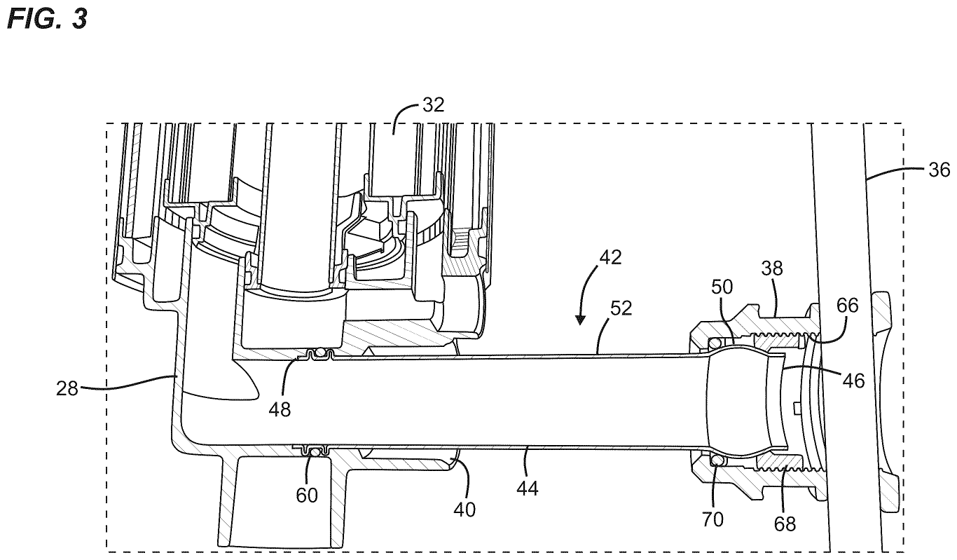

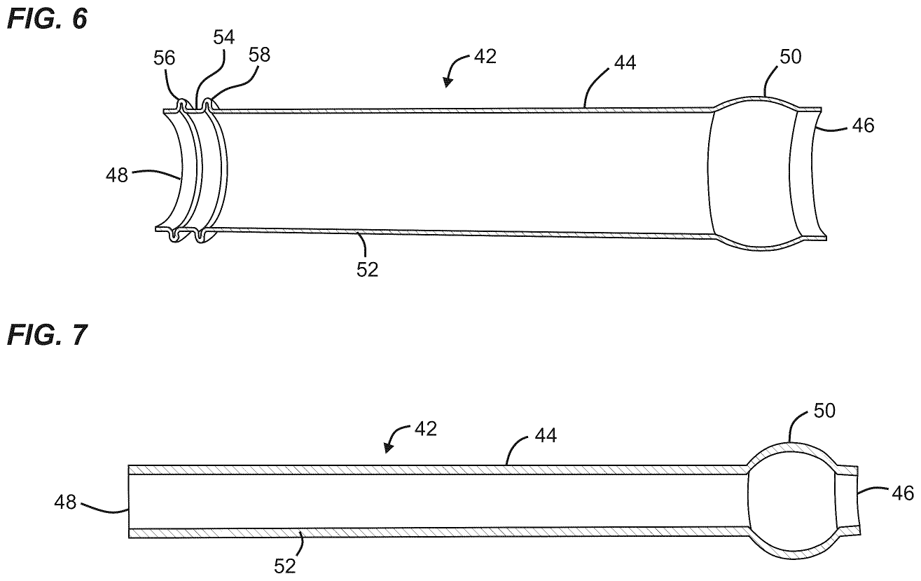

In FIGS. 1 and 3, a flow tube 42 is shown connecting the bulkhead fitting 38 to the flow port 40 in the filter head 28. In reference now to FIGS. 6 and 7, the flow tube 42 includes a hollow tube 44 having a first open end 46 and a second open end 48. The flow tube 42 further includes a first bulbous-shaped wall 50 received within a first of the bulkhead fitting 38 or the flow port 40. By “bulbous,” it is meant bulging, or in a shape that looks generally like a bulb with an outer roundish or fat appearance.

The first bulbous-shaped wall 50 is illustrated here as adjacent (next to) the first open end 46, while the tube 42 adjacent the second open end 48 is straight (FIG. 7). However, the bulbous-shaped wall 50 could also be adjacent to the second open end 48. In some embodiments, there could be a bulbous shaped wall adjacent both the first open end 46 and second open end 48.

The hollow tube 44 comprises a straight section 52 between the first bulbous-shaped wall 50 and the region adjacent to the second open end 48. Preferably, the hollow tube 44 consists of straight section 52 between the first bulbous-shaped wall 50 and the region adjacent to the opposite second open end 48. By “region adjacent”, it is meant that the straight section 52 extends to either the second open end 48 or to a second bulbous shaped wall, or an o-ring seat groove (explained below).

Preferably, the straight section 52 of the tube 44 is cylindrical. The first bulbous-shaped wall 50 has a largest diameter that is 1.01-1.1 times larger than a diameter of the straight section 52 of the tube 44. Alternatively, the first bulbous-shaped wall 50 has a largest diameter that is 1.1 to 1.2 times larger, or 1.2 to 1.3 times larger, or 1.3 to 1.4 times larger than a diameter of the straight section 52 of the tube 44. Alternatively, the first bulbous-shaped wall 50 has a largest diameter that is between 1.4 and 1.01 times larger, or between 1.3 and 1.1 times larger, or between 1.3 and 1.2 times larger than a diameter of the straight section 52 of the tube 44.

The flow tube 42 can be made from non-metal, such as plastic. Alternatively, the flow tube 42 can be made of metal or a composite material.

In FIG. 6, the tube 44 adjacent the second open end 48 defines an o-ring seat groove 54. The groove 54 is between a pair of protrusions 56, 58 projecting from a remaining part of the tube 44. The groove 54 holds an o-ring seal member 60 (FIG. 3) for forming a seal in the port 40 of the filter head 28.

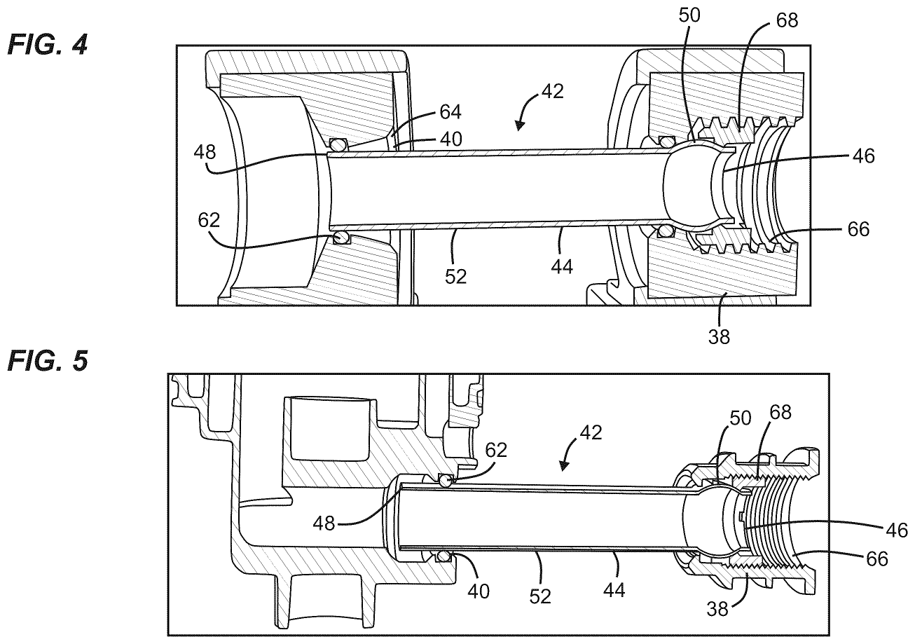

In the embodiment of FIG. 7, the tube 42 adjacent the second open end 48 is straight. In that case, there is an o-ring seal member 62 (FIGS. 4 and 5) integrated into the port 40 of the filter head 28. FIGS. 4 and 5 show two different types of filter head ports 40. In FIG. 4, there is a wider lead-in mouth 64 for the port 40, and the seal member 62 is recessed from the outer edge of the port 40. In FIG. 5, the seal member 62 is next to the outer edge of the port 40.

FIGS. 3-5 show the connection of the tube 42 with the bulkhead fitting 38. The fitting 38 is insert molded into the tank wall 36; alternatively, if the tank wall 36 is made from steel, the fitting 38 can be welded. The fitting 38 has inner threads 66. A fastener, such as a threaded capture nut 68, connects via threaded connection to the inner threads 66 and secures the first open end 46 of the tube 42 within the fitting 38. An o-ring seal member 70 is positioned within the fitting 38 to form a seal with the tube 42, and in this case with an outer portion of the bulbous shaped wall 50.

As can be appreciated from a review of FIGS. 3-5, the bulbous shaped wall 50 accommodates alignment issues between the port 40 in the filter head 28 and the wall 38 of the tank 22. If there is some misalignment due to, for example, a molded tank, the bulbous shaped wall 50 will take up “slop” and result in a tight seal with the seal member 70.

The above represents example principles. Many embodiments can be made using these principles.

What is claimed is:

1. A flow tube for use connecting a filter head to a bulkhead fitting in a tank; the flow tube comprising:
(a) a hollow tube having a first open end and a second open end;
(b) the tube having a first bulbous-shaped wall adjacent to at least one of the first open end or second open end.

2. The flow tube of claim 1 wherein the tube has the first bulbous-shaped wall adjacent to the first open end, and includes a second bulbous-shaped wall adjacent to the second open end.

3. The flow tube of claim 1 wherein the hollow tube consists of a straight section of the tube between the first bulbous-shaped wall and the opposite first open end or second open end.

4. The flow tube of claim 3 wherein the straight section of the tube is cylindrical.

5. The flow tube of claim 4 wherein the first bulbous-shaped wall has a largest diameter that is 1.01-1.1 times larger than a diameter of the straight section of the tube.

6. The flow tube of claim 4 wherein the first bulbous-shaped wall has a largest diameter that is 1.1-1.2 times larger than a diameter of the straight section of the tube.

7. The flow tube of claim 4 wherein the first bulbous-shaped wall has a largest diameter that is 1.2-1.3 times larger than a diameter of the straight section of the tube.

8. The flow tube of claim 4 wherein the first bulbous-shaped wall has a largest diameter that is 1.3-1.4 times larger than a diameter of the straight section of the tube.

9. The flow tube of claim 4 wherein the first bulbous-shaped wall has a largest diameter that is between 1.4 and 1.01 times larger than a diameter of the straight section of the tube.

10. The flow tube of claim 4 wherein the first bulbous-shaped wall has a largest diameter that is between 1.3 and 1.1 times larger than a diameter of the straight section of the tube.

11. The flow tube of claim 4 wherein the first bulbous-shaped wall has a largest diameter that is between 1.3 and 1.2 times larger than a diameter of the straight section of the tube.

12. The flow tube of claim 1 wherein the flow tube is plastic.

13. The flow tube of claim 1 wherein the flow tube is metal.

14. The flow tube of claim 1 wherein the first bulbous-shaped wall is adjacent to the first open end, and the tube adjacent the second open end is straight.

15. The flow tube of claim 1 wherein the first bulbous-shaped wall is adjacent to the first open end, and the tube adjacent the second open end defines an o-ring seat groove.

16. An in-tank hydraulic filter system comprising:
(a) a hydraulic tank having a surrounding wall defining an interior volume;
(i) the surrounding wall having a bulkhead fitting providing access to the interior volume;
(b) a filter assembly mounted in the interior volume of the tank; the filter assembly having a filter head with flow port; and
(c) a flow tube connecting the bulkhead fitting to the flow port in the filter head; the flow tube including:
(i) a hollow tube having a first open end and a second open end; and
(ii) a first bulbous-shaped wall received within a first of the bulkhead fitting or the flow port.

17. The system of claim 16 wherein the bulkhead fitting includes an o-ring seal member located to form a seal with the flow tube.

18. The system of claim 16 wherein the flow port includes a flow port o-ring seal member located to form a seal with the flow tube.

19. The system of claim 16 wherein the first bulbous-shaped wall is adjacent to the first open end, and the tube adjacent the second open end defines an o-ring seat groove.

20. The system of claim 16 wherein the tank is plastic.

21. The system of claim 16 wherein the tank is metal.
